(19) United States
(12) Patent Application Publication
(10) Pub. No.: US 2022/0164847 A1
(43) Pub. Date: May 26, 2022

(54) BORROW BACKS MOBILE APP

(71) Applicant: Matthew Lawrence Reiter, Las Vegas, NV (US)

(72) Inventor: Matthew Lawrence Reiter, Las Vegas, NV (US)

(21) Appl. No.: 17/100,447

(22) Filed: Nov. 20, 2020

(51) Int. Cl. G06Q 30/06; G06Q 20/40; G06F 16/22; G06F 16/953

(52) U.S. Cl. CPC G06Q 30/0625; G06Q 30/0645; G06Q 30/0633; G06Q 30/0609; G06Q 20/4037; H04L 67/42; G06Q 30/0643; G06Q 30/0639; G06F 16/22; G06F 16/953; G06Q 20/407

(57) ABSTRACT

A system and method for providing a searchable rental sales service uses a web server being configured to communicatively interconnect a client device, one or more vendor computing devices, to the web server over the Internet, The web server receives a new item offer listing for a rental item available, stores the new item offer listing into a rental item database, receives a user authentication, receives a search query for rental items stored in the database, transmits a set of search results generated using the search query, receives a preview request for a particular rental item, provides the rental item listing corresponding to the preview request, receives a rental order for the rental item corresponding to the preview request, and transmits the rental order to the vendor.

### TECHNICAL FIELD

This application relates in general to a system and method for providing local retail services, and more specifically, to a system and method for providing a searchable rental sales service.

### BACKGROUND

Travelers, casual users, and similar individuals occasionally require locating items of various kinds for use during a given time period. Vacation travelers may wish to use bicycles, motor bikes, canoes, and other travel aids for use while exploring a travel location. Homeowners may need to use specialty items while performing house repairs and landscaping tasks. Business owners may need to use technology items to assist in sales presentations to prospective clients. Many other individuals may encounter similar needs at various times.

The task to easily locate items near an individual's current location that may be needed for a short period of time without a significant amount of planning and effort is typically a difficult, time-consuming, and frustrating activity. Vendors that may provide these items for rental face the similarly difficult task of providing information regarding the location and availability of such items to these individuals in a manner that both facilitates the rental of the needed items as well as provides confidence to individuals that finding these items when needed is possible with minimal effort.

Therefore, a need exists for a system and method providing users with a searchable rental sales service in a local area. Such a system and method may provide real-time availability and inventory of desired items as well as their locations relative to a user's present position with an ability to reserve and rent these items when needed. The present invention attempts to address the limitations and deficiencies of existing solutions according to the principles and example embodiments of the present invention disclosed herein.

### SUMMARY

In accordance with the present invention, the above and other problems are solved by providing a system and method for a searchable rental sales service according to the principles and example embodiments disclosed herein. In one embodiment, the present invention is a system providing a searchable rental sales service from specific sources and locations. The system providing a searchable rental sales service uses a web server being configured to communicatively interconnect a client device, one or more vendor computing devices, to the web server over the Internet, The web server receives a new item offer listing for a rental item available, stores the new item offer listing into a rental item database, receives a user authentication, receives a search query for rental items stored in the database, transmits a set of search results generated using the search query, receives a preview request for a particular rental item, provides the rental item listing corresponding to the preview request, receives a rental order for the rental item corresponding to the preview request, and transmits the rental order to the vendor.

In another embodiment, the present invention is a method for providing a searchable rental sales service from specific sources and locations. The method for providing a searchable rental sales service uses a web server being configured to communicatively interconnect a client device, one or more vendor computing devices, to the web server over the Internet, The web server receives a new item offer listing for a rental item available, stores the new item offer listing into a rental item database, receives a user authentication, receives a search query for rental items stored in the database, transmits a set of search results generated using the search query, receives a preview request for a particular rental item, provides the rental item listing corresponding to the preview request, receives a rental order for the rental item corresponding to the preview request, and transmits the rental order to the vendor.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates a system for providing a searchable rental sales service according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIGS. 3a-k illustrate a set of screenshots for an example embodiment of a mobile application as part of a system providing a searchable rental sales service according to the present invention.

FIGS. 4a-b illustrate sets of computing systems of software components of a system providing a searchable rental sales service according to the present invention.

FIG. 5 illustrates a flowchart corresponding to a method performed by software components of a web server user account processes within a system providing a searchable rental sales service according to the present invention.

FIG. 6 illustrates a flowchart corresponding to a method performed by software components of a vendor application within a system providing a searchable rental sales service from specific sources and locations according to the present invention.

FIG. 7 illustrates a flowchart corresponding to a method performed by software components of a renter application within a system providing a searchable rental sales service from specific sources and locations according to the present invention.

### DETAILED DESCRIPTION

This application relates in general to a system and method for providing retail services, and more specifically, to a system and method for providing a searchable rental sales service according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The term “mobile application” refers to an application executing on a mobile device such as a smartphone, tablet, and/or web browser on any computing device.

The terms “individual” and “user” refer to an entity, e.g. a human, using a system providing a searchable rental sales services including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or wireless connection(s) using any type of frequency/frequencies or radio wave(s). Some examples are including below in this application.

The term “invention” or “present invention” refers to the invention being applied for via the patent application with the title “Borrow Back Mobile App.” Invention may be used interchangeably with rental app.

The terms “communicate,” or “communication” refer to any component(s) connecting with any other component(s) in any combination for the purpose of the connected components to communicate and/or transfer data to and from any components and/or control any settings.

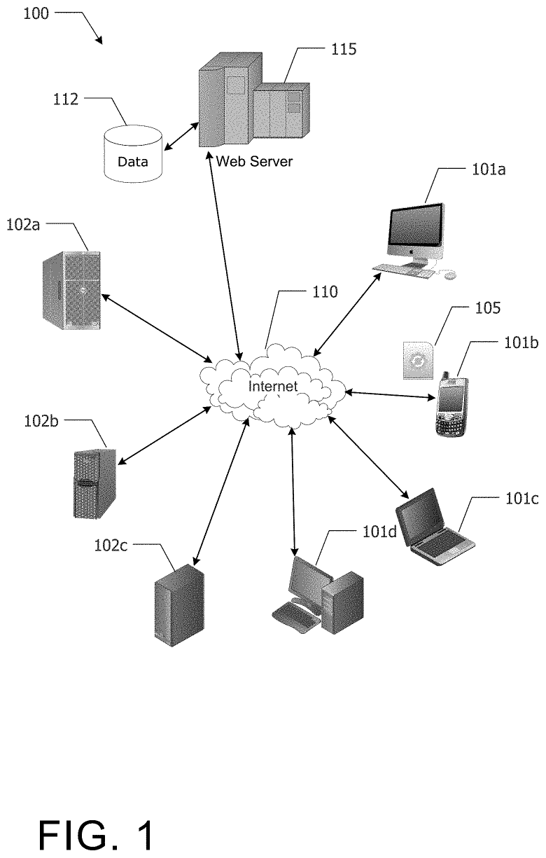

In general, the present disclosure relates to a system and method for providing a searchable rental sales service. To better understand the present invention, FIG. 1 illustrates a system for providing a searchable rental sales service according to the present invention. The system 100 connects potential renters 101a-d with vendors 102a-c using a web server 115 communicating over the Internet 110. A mobile application 105 executes on renter devices 101a-d to permit the users to locate items for rent that are currently available from vendors who are nearby. The mobile application 105 interacts with the web server 115 to perform searches, communicate with vendors, place orders for a rental, make payment for the rental, and find directions to the vendor's location.

The vendors computing systems 102a-c permit the vendors to list items available for rent with the web server after the vendor has established an account, including one or more physical locations at which rented items may be obtained and returned. All of the listed items are maintained within a rental item database 112 attached to the web server 115. The web server 115 communicates with the vendors' computing systems 102a-c to provide an up-to-date status of available inventory of listed items that are used when renters perform searches for items to rent. When a renter makes an online rental with the mobile application 105, the web server 115 notes the change in inventory for the vendor as well as sends the rental order and payment to the vendor's computing system 102a-c.

Consider a following example. A user wants to rent a bicycle, ATV, ski gear, boat, moving truck, tractor, or similar item. The user can simply utilize the mobile app 105 to search for a desired item. The mobile application 105 will perform a search for the requested item within the rental item database 112 and generate a set of search results showing available items corresponding to the search request. The search results include information showing available items' locations and information regarding how far the vendor rental shop may be as well as pricing for the rental. The user may select the item to be rented and complete the rental transaction using the mobile app 105. The mobile app 105 presents all relevant agreements, disclosure documents, and related information needed to be accepted to consummate the rental agreement. This exchange of documents also may include liability waiver agreements as part of any rental contract.

The renter may electronically execute the required agreements through the mobile app 105. All of these documents are sent to the web server 115 for storage. Copies of these documents also are sent to the vendor's computing system 102a-c so that when the renter picks up the rental item, it is as easy as walking in, picking up the rental, and leaving.

The mobile app 105 may also allow renters to search and browse for rental shops nearby, as well as present featured shops that pay to be showcased to renters on the mobile app 105 when renters are nearby. Users may then select a rental item that they would like to rent. The mobile app 105 then displays how long a renter may rent the selected item and the rental price (ex. 4 hours for $25). The mobile app 105 provides information regarding when the rented item will be available, if it is not currently awaiting a rental, and then provides information regarding when the user can pick up the rented item along with its pickup location.

Once a user is ready to rent the item, the renter completes and executes all required documents as specified by the rental vendor. The user of the mobile app 105 may store payment information into a user profile maintained by the web server 115 for use when a rental agreement is completed. This payment information may be used to confirm availability of funds to pay for the rental at the time of the agreement to ensure the vendor obtains payment. The payment information also may be entered into the mobile app 105 by the renter at the time of rental.

The system 100 may use any type of network such as a single network, multiple networks of a same type, or multiple networks of different types which may include one or more of a direct connection between devices, including but not limited to a local area network (LAN), a wide area network (WAN) (for example, the Internet), a metropolitan area network (MAN), a wireless network (for example, a general packet radio service (GPRS) network), a long term evolution (LTE) network, a telephone network (for example, a Public Switched Telephone Network or a cellular network), a subset of the Internet, an ad hoc network, a fiber optic network (for example, a fiber optic service (often known as FiOS) network), or any combination of the above networks.

Smart devices mentioned herein the present application may also use one or more sensors to receive or send signals, such as wireless signals for example, Bluetooth™, wireless fidelity, infrared, Wi-Fi, or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The invention's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods were described without reference to the specific software or firmware code. Software, smart device application(s), firmware, and control hardware can be designed to implement the systems and methods based on the description herein.

While all of the above functions are described to be provided to users via a mobile application on a smartphone, one of ordinary skill will recognize that any computing device including tablets, laptops, and general-purpose computing devices may be used as well. In at least one embodiment, all of the services described herein are provided using web pages being accessed from the web server 201 using a web browser such as Safari™, Firefox™, Chrome™, DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 110. These computing devices may include smartphones 101b, laptop computers 101c, tablets (not shown), desktop devices 101a and similar devices 101d so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

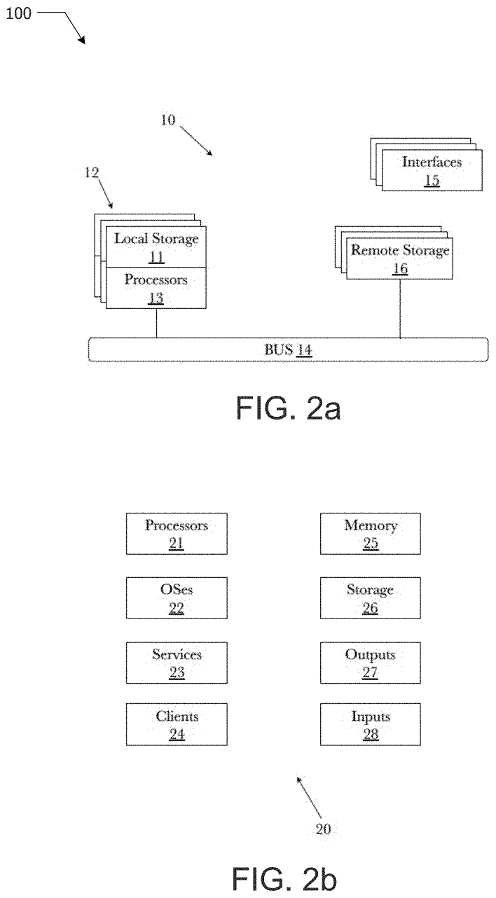

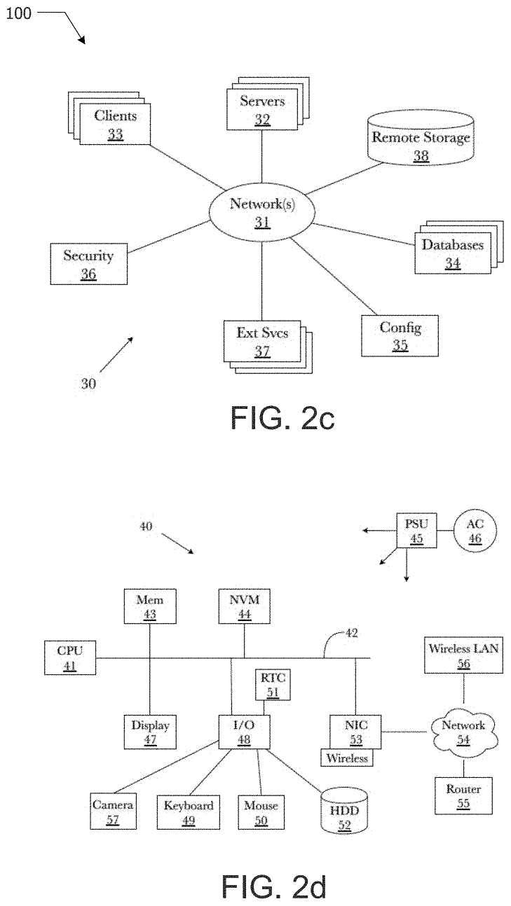

Referring now to FIG. 2a, there is a block diagram depicting an exemplary computing device 10 suitable for implementing at least a portion of the features or functionalities disclosed herein. The computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network, a metropolitan area network, a local area network, a wireless network, the Internet or any other network, using known protocols for such communication, whether wireless or wired.

In one aspect, the computing device 10 includes one or more central processing units (CPU) 12, one or more interfaces 15, and one or more buses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random-access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-Patent a-chip-(SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent, or files containing higher level code that may be executed by the computer using an interpreter (for example, scripts written in Python™, Perl™, Ruby™, Groovy™, or any other scripting language).

In some aspects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system, or the like. In many cases, one or more shared services 23 may be operable in system 20 and may be useful for providing common services to client applications 24. Services 23 may, for example, be WINDOWS™ services, user-space common services in a LINUX™ environment or any other type of common service architecture used with an operating system 22. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to system 20, and may include, for example, one or more screens for visual output, speakers, printers or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 2b. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to bus 42, to which bus is also connected to memory 43, non-volatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

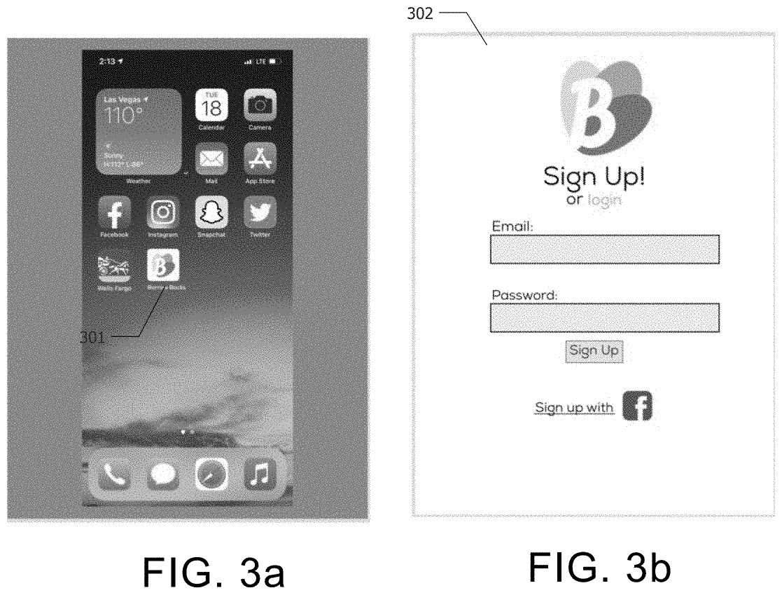

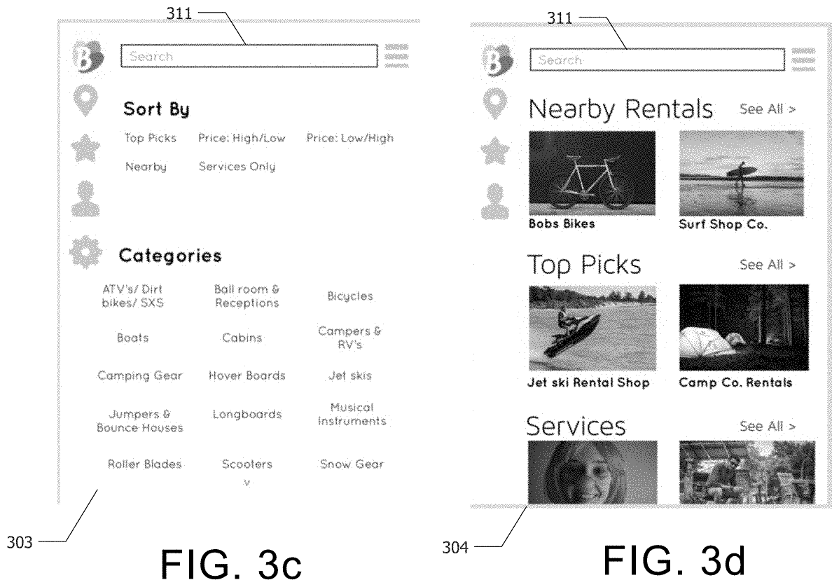

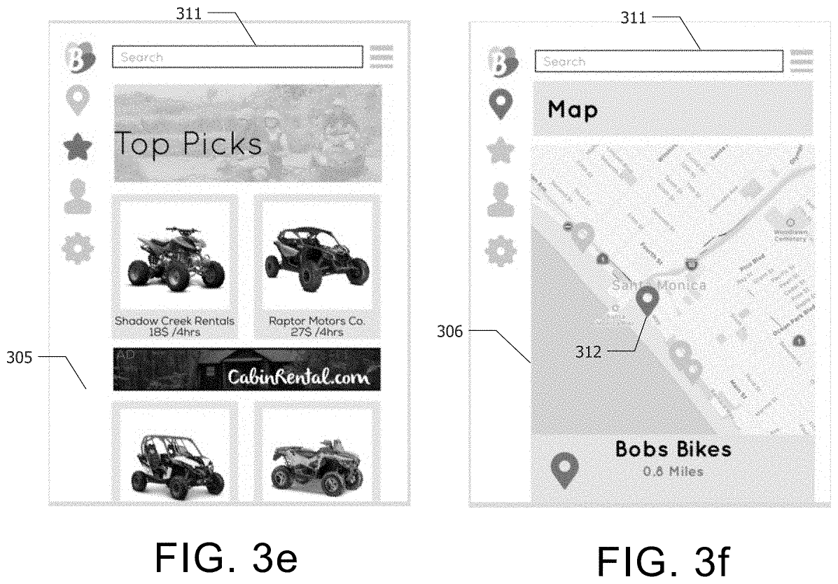

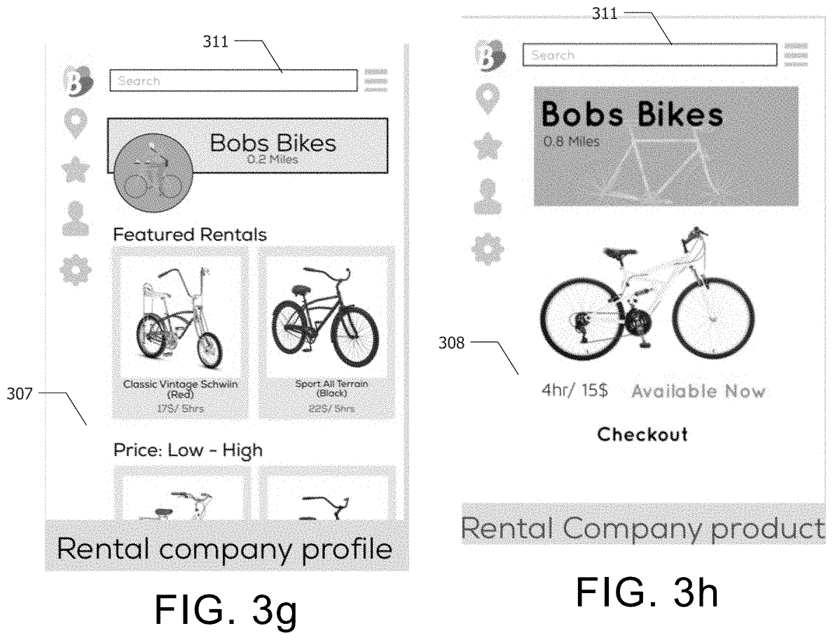

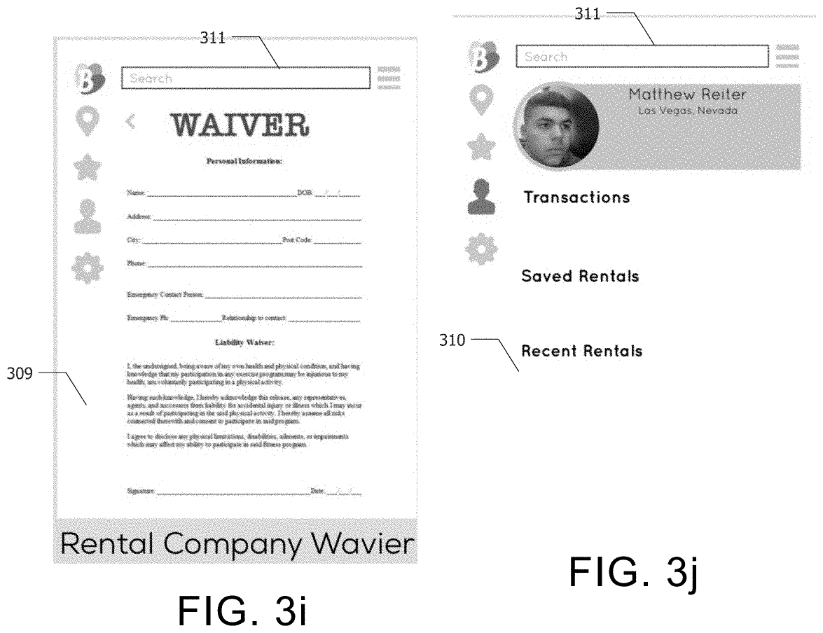

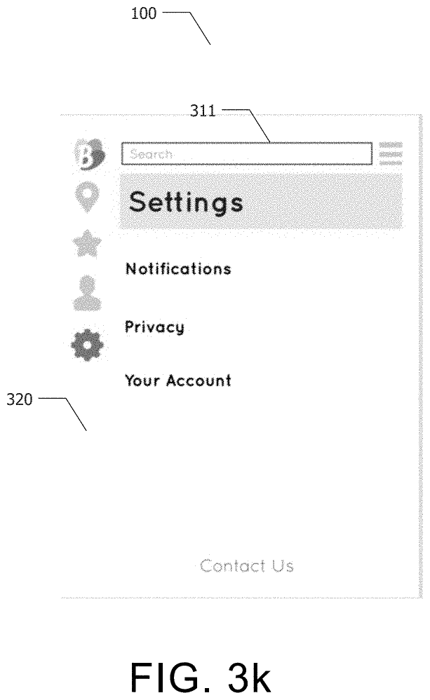

FIGS. 3a-k illustrate a set of screenshots for an example embodiment of a mobile application as part of a system providing a searchable rental sales service according to the present invention. FIG. 3a shows a mobile app 301 available for use on a mobile device that provides a system and method for providing a searchable rental sales service according to the present invention. The mobile application 301 may be a native application running on the mobile device as well as a web-based one in which the user interacts with the web server 115 using a web browser (not shown).

FIG. 3b shows a user login screen used by vendors and renters to gain access to the web server and the functionality of the system 100 providing a searchable rental sales service according to the present invention. An email address may be used as a unique user ID corresponding to the user. An individual password also is required to authenticate the user to the web server 115. Multi-factor authentication may be utilized to further ensure that the user accessing the web server 115 corresponds to the individual associated with each user account.

FIG. 3c shows a search and browse by category mobile application screen 303 having a search field and a listing of available categories for browsing.

FIG. 3d shows a search and browse by nearby location, top picks, and listed services mobile application screen 304 with a search field and a listing of available rental categories for browsing.

FIG. 3e shows a search and browse by top picks of nearby rental shops for a given category mobile application screen 305 with a search field and a listing of nearby rental locations for browsing.

FIG. 3f shows a rental location map mobile application screen 306 with a location marking the rental shop on a map.

FIG. 3g shows a browse by available items for rent mobile application screen 307 for a selected rental shop location for browsing.

FIG. 3h shows an item mobile application screen 308 for a particular item available for rent from a specific rental vendor and location.

FIG. 3i shows an example rental document mobile application screen 309 to be completed when a rental agreement it to be executed.

FIG. 3j shows a user mobile application screen 310 for an individual renter user of the mobile application 105.

FIG. 3k shows a setting mobile application screen 320 for the mobile application 105 that permits the renter user to specify information and setting values to be used when the user interacts with the web server 115.

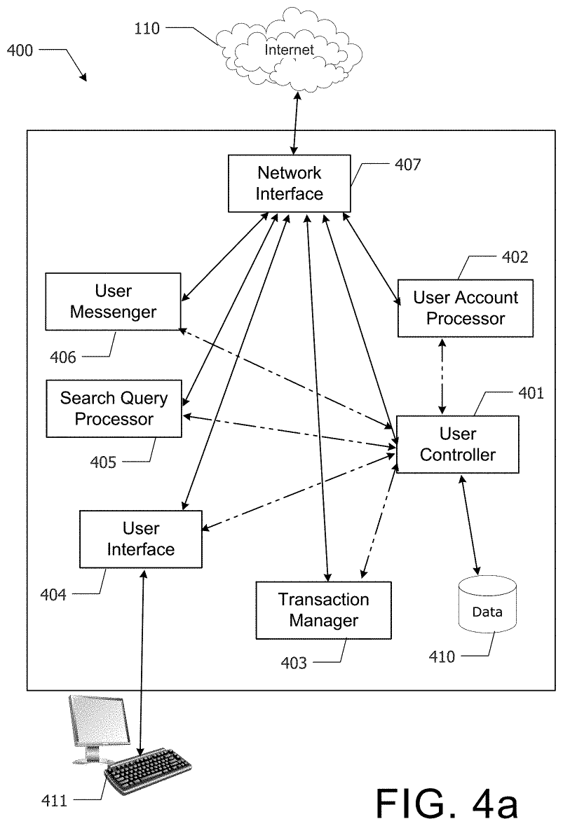

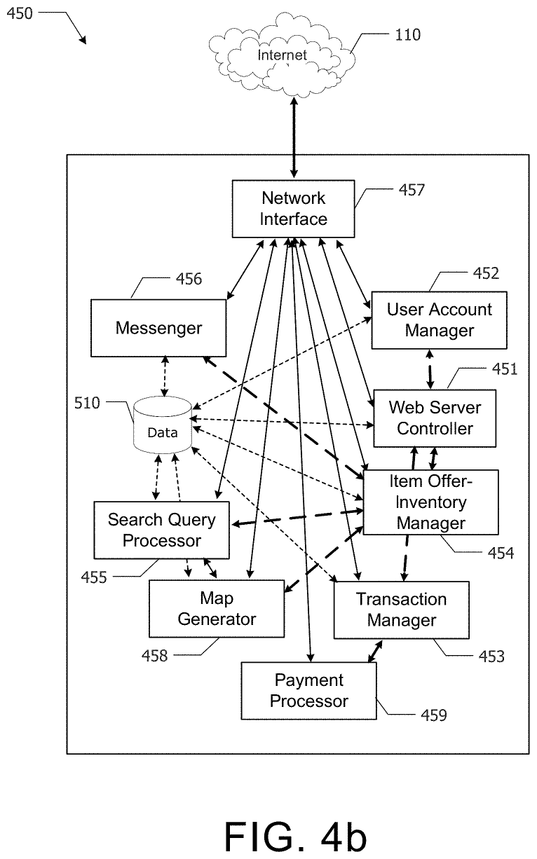

FIGS. 4a-b illustrate sets of computing systems of software components of a system providing a searchable rental sales service according to the present invention. FIG. 4a shows a set of processing components within the mobile application 105 used when a renter interacts with the web server 115. The set of processing components 400 within the mobile application 105 comprises a user controller 401, a user account processor 402, a transaction manager 403, a user interface 404, a search query processor 405, a user messenger 406, a web interface 407, and local data storage 410.

The user controller 401 coordinates the message processing within the mobile application 105 as it generates search queries, receives search results, generates rental order messages, and completes rental transactions.

The user account processor 402 permits users to connect to and access the web server 115. The user account processor 402 is responsible for authenticating a user based upon user input on the web server 115. Typically, the user input uses a username and password. Multi-factor authentication, use of one-time passwords, and similar secure authentication mechanisms may be included in the user profile. For every sign-in the system will recognize the user type, i.e., renter or vendor, along with all past activities from account details in the database. Based on user type, the system 100 behavior will change.

The transaction manager 403 generates rental order messages for the mobile applications 105 for transmission to the web server 115 via the user messenger 406. The transaction manager 433 receives any responsive messages including messages containing rental agreement documents, liability waiver agreements, rental disclosure information, and all related documents used to complete a transaction. The transaction manager 403 communicates with the web server 115 as required as a rental is being completed. The mobile application 105 also may send information request messages from the renters that are to be forwarded to the vendor computing systems 102a-c. The rental vendors may respond with messages that are received by the mobile application 105.

The user interface 404 provides input and output processing to provide a driver with messages and data needed to perform the search queries, communicate messages to and from vendors, and complete rental agreements. This user interface module 404 also accepts commands from the renters to instruct the application to perform these tasks.

The search query processor 405 generates a query or browse request based upon user input via the user interface 404 that is sent to the web server 115 via the network interface 407. The query or browse request includes search terms, category names, and mobile application location data that are used by the search query processor 455 of the web server 115 to generate search results. The search results are returned from the web server 115 and processed to present to the user via the user interface 404.

The user messenger 406 sends and receives messages with the web server 115 and with vendor computing systems 102a-c. All communications to and from the mobile application 105 are processed by the user messenger 406 via the web interface 407.

The web interface 407 permits the mobile application 105 to communicate with remote vendor computing devices 102a-c and the web server 115. The web interface 407 performs all of the data formatting, computer to computer communications, encryption processing, and all similar operations needed by the mobile application 105 to communicate with other computing systems.

The local data storage 410 stores data for the mobile application 105 including payment information, past messages, and prior rental transactions.

FIG. 4b shows a set of processing components within the web server 115 used when a mobile application 105 interacts with the web server 115. The set of processing components 450 within the web server 115 comprises a web server controller 451, a user account processor 452, a transaction manager 453, an item offer-inventory manager 454, a search query processor 455, a messenger 456, a network interface 457, a map generator 458, a payment processor 459, and local data storage 460.

The web server controller 451 receives the search query messages via the network 457 from the mobile application 105. The web server controller 451 also forwards the search queries to the search query processor 455 for processing. The web server controller 451 then sends the search results back to the mobile application 105. The web server controller 451 also receives and coordinates the processing of rental offers received from the mobile application 105 with the transaction manager 452 and the payment processor 458. Rental vendors' listings of rental items are received by the web server controller 451 in messages from the vendor computing systems 102a-c for inclusion into the rental item database 112 by the item offer-inventory manager 454.

The user account manager 452 permits users to connect to and access the rental web server 115. The user account manager 452 is responsible for creating and managing user accounts for the renter computing systems 101a-d and the vendor computing systems 102a-c. The user account manager 452 also is used in authenticating a user based upon user input. Typically, the user input uses a username and password. Multi-factor authentication, use of one-time passwords, and similar secure authentication mechanisms may be included in the user profile. For every sign in the system will recognize the user type, i.e., renter computing systems 101a-d and vendor computing systems 102a-c, along with all past activities from account details in the database. Based on user type, the server 103 behavior will change.

The transaction manager 453 receives rental order messages from mobile applications 105 via the messenger 456. The transaction manager 453 generates any responsive messages including messages containing rental agreement documents, liability waiver agreements, rental disclosure information, and all related documents used to complete a transaction. The transaction manager 453 communicates with the mobile application 105 as required as a rental is being completed. The mobile application 105 also may send information request messages from the renters that are forwarded to the vendor computing systems 102a-c. The rental vendors may respond with messages that are forwarded to the mobile application 105. The transaction manager 453 utilizes the payment processor 459 to verify available funds from the renter as well as receive payment once the rental is complete.

The item offer-inventory manager 454 receives rental item listings from rental vendor computing systems 102a-c for inclusion into the rental database 112. The item offer-inventory manager 454 also maintains inventory status of rental items based upon rental data generated by the transaction manager 453 when the system 100 completes a rental agreement and from the rental vendor computing systems 102a-c when the rental item is no longer otherwise available.

The search query processor 455 generates the search results for available rental items within the database 112 based upon a query or browse request from the mobile application 105. The query or browse request includes search terms, category names, and mobile application location data that are used by the search query processor 455. The generated search results are returned to the mobile application 105 via the network interface 457.

The messenger 456 sends and receives messages from the mobile application 105 for use by the transaction manager 453 to process a rental order. The messenger also sends and receives messages from the mobile application 105 to permit renters and vendor to exchange information as necessary to determine whether a rental agreement is possible.

The network interface 457 permits the web server 115 to communicate with remote user computing devices 101a-d, 102a-c. The network interface 457 performs all of the data formatting, computer to computer communications, encryption processing, and all similar operations needed by the web server 115 to communicate with user computing systems.

The map generator 458 retrieves search terms, category names, and mobile application location data that are used by the search query processor 455 as well as corresponding search results to generate a map of nearby rental locations to the user mobile application. Travel routes from a user's location to a rental location also may be generated. These maps and travel routes are sent to the mobile application 105 for use by the user. Users may zoom into and out of a map to view rental locations for a particular region of the map at a desired spatial resolution.

The payment processor 459 receives payment information from a renter's mobile application 105 and a rental amount from the transaction manager 453 to communicate with third party payment systems to check available funds and obtain payment from the renter's accounts to complete payment for a rental. Indications of insufficient funds to pay for a rental are provided to the transaction manager 453 to stop a rental agreement from being accepted.

The local data storage 460 provides data storage for the web server 115 outside of the data within the rental item database 112.

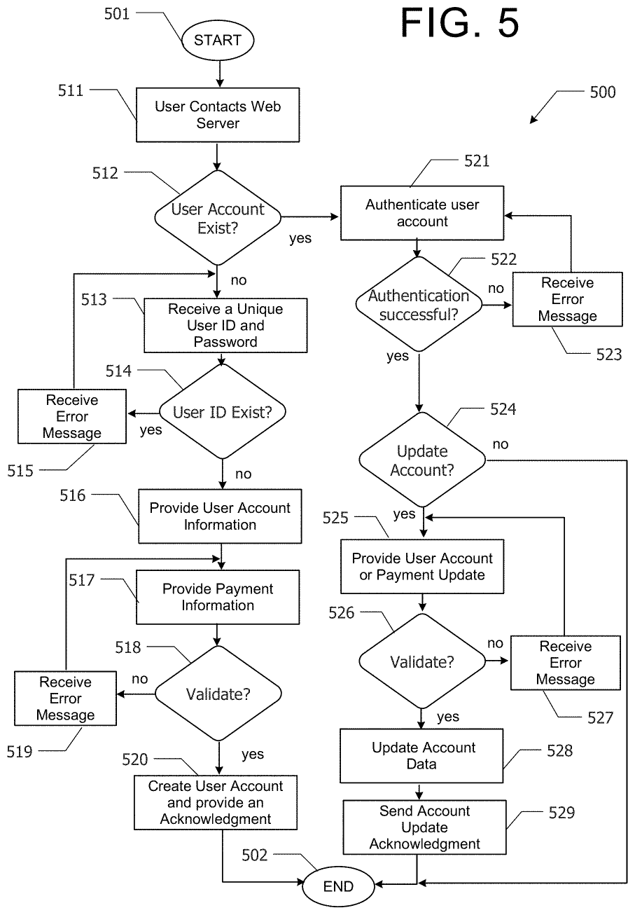

FIG. 5 illustrates a flowchart corresponding to a method performed by software components of a web server user account processes within a system providing a searchable rental sales service according to the present invention. The process 500 begins 501 when a rental user in step 511 contacts the web server 115. Test step 512 permits the web server 115 to determine whether or not the user account exists, and if so, the web server 115 authenticates the user account in step 521. This authentication may begin with a comparison of the provided user ID and password with stored values. Additional authentication may include use of a multi-factor authentication if desired.

In test step 522, the webserver 115 determines whether or not the user account has been successfully authenticated, and if not, an error message is sent to the mobile application 105 is step 523 and the process 500 returns to step 521 to try again. This attempt to authenticate a user may be terminated if the authentication fails after a predetermined number of attempts. When the user account has been authenticated, the process 500 provides the user with account information and determines if the account is to be updated in test step 524, and if not, the process 500 ends 502. If test step 524 determines that the account information is to be updated, the web server receives updated user information in step 525 that is validated in test step 526. If the updated user information is not validated in test step 526, an error message is sent to the mobile application in step 527 and the process 500 returns to step 525 to try again. When the updated information is validated in test step 526, the user account information is updated in step 528. An acknowledgement of the user account update is sent to the mobile application 105 in step 529 and the process 500 ends 502.

Returning to test step 512, when the user account has been determined not to exist, the web server 115 receives a unique user ID and password from the mobile application 105 in step 513. The web server determines in test step 514 whether the user ID is already in use, and if so, an error messages is generated in step 515 and the process 500 returns to step 513 to try again. If test step 514 determines that the user ID is not in use, the web server 115 receives all of the user account information in step 516 and user payment information in step 517. The web server 115 validates the payment information in test step 518, and if it does not successfully validate, the process 500 returns to step 513 to try again. If test step 518 successfully validates the payment information, the user account is created in step 520 and the process 500 ends 502.

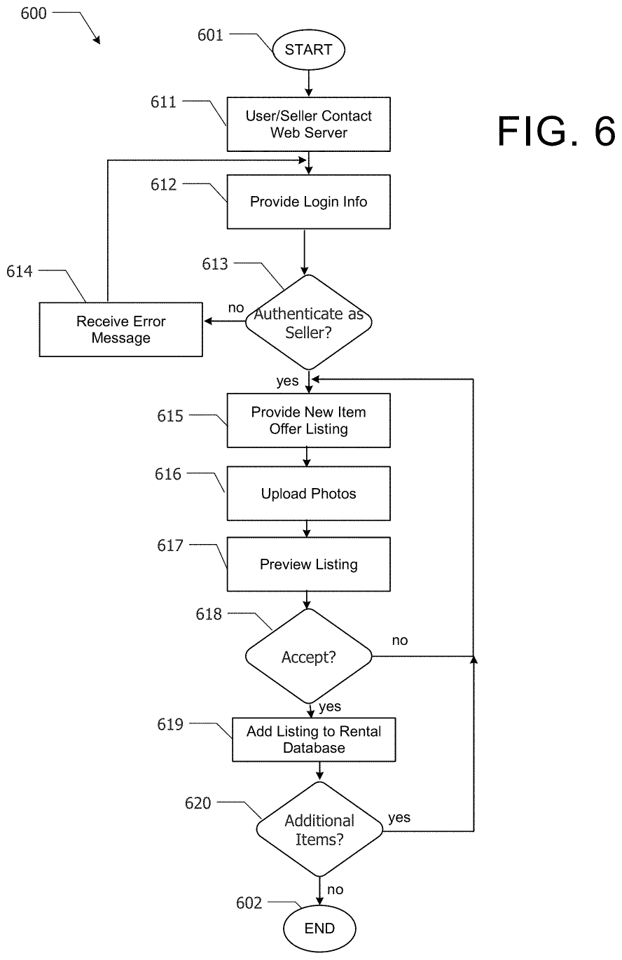

FIG. 6 illustrates a flowchart corresponding to a method performed by software components of a vendor application within a system providing a searchable rental sales service from specific sources and locations according to the present invention. The process 600 begins 601 when a vendor computing system 102a-c contacts the web server 115 in step 611. The vendor provides login information in step 612. This login information may include a user ID, a password, and any multi-factor authentication information needed to complete the authentication.

The web server 115 in test step 613 determines whether or not the vendor has been authenticated, and if not, an error message is generated in step 614 and the process 600 returns to step 612 to try again. This attempt to authenticate a user may be terminated if the authentication fails after a predetermined number of attempts. When the vendor is authenticated in test step 613, the web server 115 receives a new rental offer listing in step 615 and corresponding photos in step 616. The new listing is presented to the vendor for review in step 617. The web server 115 determines in test step 618 whether or not the vendor accepts the previewed listing, and if not, the process 600 returns to step 615 to update and resubmit the listing. When test step 618 determines that the previewed listing has been accepted, the listing is added to the rental item database in step 619. Test step 620 determines whether or not the vendor wants to add any additional listings, and if so, the process 600 returns to step 615 to process the next listing; otherwise the process 600 ends 602.

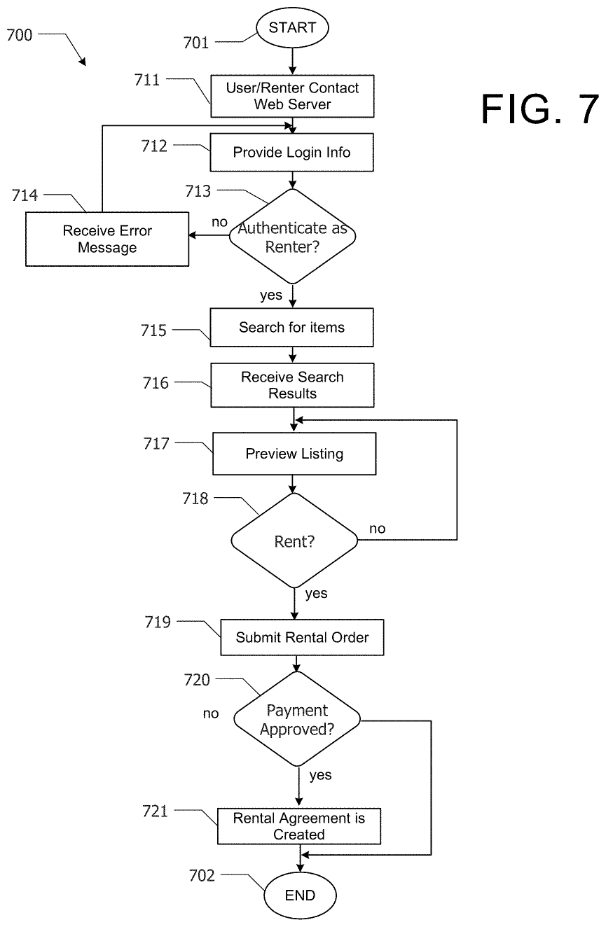

FIG. 7 illustrates a flowchart corresponding to a method performed by software components of a web server when a renter searches and rents an item using a system providing a searchable rental sales service from specific sources and locations according to the present invention. The process 700 begins 710 when a mobile application 105 contacts the web server in step 711. The renter provides the web server login information in step 712 which is authenticated in test step 713. If the log in information is not authenticated an error message is generated in step 714 and the process 700 returns to step 712 to try again. This attempt to authenticate a user may be terminated if the authentication fails after a predetermined number of attempts.

When test step 713 successfully authenticates a user, the renter may search for items to rent in step 715 by submitting a search query. Search results are generated and sent to the mobile application 105 in step 716. A renter may select a particular item to review which is previewed in step 717. Test step 718 determines whether or not the renter wishes to rent the selected item, and if not the process 700 returns to step 717 to preview additional items.

When test step 718 determines that a selected item is to be rented, the web server receives a rental order message from the mobile application 105 in step 719. Test step 720 determines whether or not the payment processor 458 determined that sufficient funds are available from the renter, and if there are not sufficient funds, the process ends 702. When test step 720 determines that sufficient funds are available, the rental agreement is processed in step 721, including exchanging of all required electronic documents, before the process 700 once again ends 702.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

In the present application, all or any part of the invention's software or application(s) or smart device application(s) may be installed on any of the user's or operator's smart device(s), any server(s) or computer system(s) or web application(s) required to allow communication, control, and transfer of content(s) or data between any combination of the components.

What is claimed is:

1. A system for providing a searchable rental sales service, the system configured to communicatively interconnect a client device, one or more vendor computing devices, and a web server, the web server comprising:
a memory having instructions stored thereon; and
a processor configured to execute the instructions on the memory to cause the electronic apparatus to:
receive a new item offer listing for a rental item available from the vendor computing device;
store the new item offer listing into a rental item database;
receive a user authentication from the client device;
receive a search query for rental items stored in the database from the client device;
transmit a set of search results generated using the search query to the client device;
receive a preview request for a particular rental item from the client device;
provide the rental item listing corresponding to the preview request to the client device;
receive a rental order from the client device for the rental item corresponding to the preview request; and
transmit the rental order to the vendor computing device.

2. The system according to claim 1, wherein the processor is further configured to cause the web server to:
receive a vendor authentication from the vendor computing device;
determine whether the vendor authentication is invalid; and
when the vendor authentication is determined to be invalid, terminate communications with the vendor computing device.

3. The system according to claim 1, wherein the processor is further configured to cause the web server to:
receive a user authentication from the client device;
determine whether the user authentication is invalid; and
when the user authentication is determined to be invalid, terminate communications with the client device.

4. The system according to claim 3, wherein the processor is further configured to cause the web server to:
provide payment information for use with the rental order;
determine whether the payment information provides sufficient funds to provide for the cost of the rental order; and
when the payment information is determined to be inadequate to provide for the cost of the rental order, notify the client device and cancel the rental order.

5. The system according to claim 1, wherein the set of search results comprise:
a written description of the rental item corresponding to each item within the search results;
one or more photographs of the rental item corresponding to each item within the search results;
identity and location of the vendor offering the rental item; and
a map containing directions from a current location of the client device to the location of the vendor.

6. A method for providing a searchable rental sales service using a web server, the web server being configured to communicatively interconnect a client device, one or more vendor computing devices, to the web server over the Internet, the method comprising:
receiving a new item offer listing for a rental item available from the vendor computing device;
storing the new item offer listing into a rental item database;
receiving a user authentication from the client device;
receiving a search query for rental items stored in the database from the client device;
transmitting a set of search results generated using the search query to the client device;
receiving a preview request for a particular rental item from the client device;
providing the rental item listing corresponding to the preview request to the client device;
receiving a rental order from the client device for the rental item corresponding to the preview request; and
transmitting the rental order to the vendor computing device.

7. The method according to claim 6, wherein the method further comprises:
receiving a vendor authentication from the vendor computing device;
determining whether the vendor authentication is invalid; and
terminating communications with the vendor computing device when the vendor authentication is determined to be invalid.

8. The method according to claim 6, wherein the method further comprises:
receiving a user authentication from the client device;
determining whether the user authentication is invalid; and
terminating communications with the client device when the user authentication is determined to be invalid.

9. The method according to claim 8, wherein the method further comprises:
providing payment information for use with the rental order;
determining whether the payment information provides sufficient funds to provide for the cost of the rental order; and
when the payment information is determined to be inadequate to provide for the cost of the rental order, notifying the client device and cancel the rental order.

10. The method according to claim 6, wherein the set of search results comprise:
a written description of the rental item corresponding to each item within the search results;
one or more photographs of the rental item corresponding to each item within the search results;
identity and location of the vendor offering the rental item; and
a map containing directions from a current location of the client device to the location of the vendor.
